(19) United States
(12) Patent Application Publication
(10) Pub. No.: US 2016/0340163 A1
(43) Pub. Date: Nov. 24, 2016

(54) REMOTE HOPPER RELEASE

(71) Applicant: Roura Material Handling, Inc., Clinton Township, MI (US)

(72) Inventors: Michael David Genter, Clarkston, MI (US); David Bryan Vinson, Livonia, MI (US); Joseph Anthony Frontera, Macomb Township, MI (US)

(21) Appl. No.: 15/231,301

(22) Filed: Aug. 8, 2016

Related U.S. Application Data
(63) Continuation-in-part of application No. 14/563,216, filed on Dec. 8, 2014, now Pat. No. 9,434,536.
Application No. 14/563,216 is a continuation-in-part of application No. 12/915,798, filed on Oct. 29, 2010, now Pat. No. 8,936,410.

(51) Int. Cl. B66F 9/19; B65D 88/56

(52) U.S. Cl. CPC B66F 9/19; B65D 88/56

(57) ABSTRACT

A dump body latching system for application to a self-dumping hopper having a base platform, a rotatable dump body mounted thereto and a locking pin on the rotatable dump body is configured to control rotation of the rotatable dump body thereon. The dump body latching system includes a power source, an actuator assembly including an actuator, and a controller operably connected to the actuator. The controller operates to selectively connect the power source with the actuator to selectively disengage the locking pin.

### CROSS REFERENCE TO RELATED APPLICATIONS

This application is a continuation-in-part of U.S. patent application Ser. No. 14/563,216, filed on Dec, 8, 2014, which is a continuation-in-part of U.S. patent application Ser. No. 12/915,798, filed on Oct. 29, 2010, which has been granted and assigned U.S. Pat. No. 8,936,410. The contents of U.S. patent application Ser. Nos. 14/563,216 and 12/915,798 are incorporated herein in their entirety by reference.

### FIELD OF THE INVENTION

The invention relates to the field of portable containers for the transportation of materials and, more specifically, to a self-dumping hopper having a system for remote, self-dumping actuation thereof.

### BACKGROUND

The statements in this section merely provide background information related to the present disclosure and may, or may not constitute prior art.

Containers or hoppers are typically used in manufacturing operations to facilitate the movement of various materials. Self-dumping hoppers are one genre of container that are frequently used to collect scrap material (such as from machining operations, for instance). Self-dumping hoppers may include specialized configurations that allow for relatively simple handling and movement by a fork truck, and ease of emptying as well.

A base platform may be provided that includes spaced slots, or an opening that is configured to engage the tines of a fork truck for lifting, moving and placement purposes. Mounted on the base platform is a dump body that is adapted to rest upright during filling of the hopper but that includes a geometry that, especially when filled, is biased to allow the hopper to be easily tilted towards an emptying position. A latching mechanism associated with the base platform is operable to engage a locking pin extending from the dump body to maintain it in its upright, fill position. Latching mechanisms commonly in use employ a spring biased handle that may be actuated (often by the fork truck operator), once the self-dumping hopper or material handling container has been moved into position for emptying. Activating the latching mechanism allows the dump body to rotate or hinge open from a side or bottom into a second, emptying position. Such devices typically require that the fork truck operator disembark from the fork truck and its protective surroundings to manually activate the latching mechanism handle to initiate the emptying process.

Latching mechanisms that are remotely controlled have been introduced. Such devices often include hydraulic actuators that require a fluid connection to the hydraulic system of the fork truck, if available. These devices are costly and typically require an interface with the fork truck that may either be unavailable, require retrofitting of the fork truck, or the purchase by the customer of specific fork trucks. In addition, hydraulic devices that are associated with the hydraulic system of the fork truck require a connect/disconnect operation by the operator each time that a hopper is moved, resulting in time loss and reduced efficiency. Other, less costly devices have included pull cords and pulley systems that are mounted to the fork truck, the fork truck upright, the fork carriage assembly or a combination thereof. Such devices also require integration of the release system with the fork truck which may be undesirable, require retrofitting of the fork truck, or the purchase by the customer of specific fork trucks.

### SUMMARY

In one aspect, a dump body latching system for application to a self-dumping hopper having a base platform, a rotatable dump body mounted thereto and a locking pin on the rotatable dump body is configured to control rotation of the rotatable dump body thereon. The dump body latching system includes a power source, an actuator assembly including an actuator, and a controller operably connected to the actuator. The controller operates to selectively connect the power source with the actuator to selectively disengage the locking pin.

In another aspect, a self-dumping hopper includes a base platform, a rotatable dump body mounted to the base platform and including a locking pin on the rotatable dump body, and a dump body latching system configured to control rotation of the rotatable dump body on the base platform. The dump body latching system includes an actuator assembly having an actuator, and a controller operably connected to the actuator. The controller operates to selectively disengage the dump body latching system from the locking pin.

The above features and advantages, and other features and advantages of the invention are readily apparent from the following detailed description of the invention when taken in conjunction with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1A is a perspective view of a fork truck, and a self-dumping hopper illustrated in a upright and locked mode, and embodying features of the invention;

FIG. 1B is a perspective view of a fork truck, and a self-dumping hopper illustrated in a dumping mode, and embodying features of the invention;

FIG. 2 is a perspective view of a dump body latching system with covers removed to illustrate features of the invention;

FIG. 3A is a rear view of the self-dumping hopper of FIG. 1A, in a first, locked mode;

FIG. 3B is a rear view of the self-dumping hopper of FIG. 1B, in a second, unlocked mode;

FIG. 3C is a rear view of the self-dumping hopper of FIG. 1A, in a third, locking mode;

FIG. 4 is another embodiment of the dump body latching system embodying features of the invention;

FIG. 5 is another embodiment of the dump body latching system embodying features of the invention, with a self-dumping hopper illustrated in a upright and locked mode;

FIG. 6 is a front view of the system shown in FIG. 5;

FIG. 7 is a front view of the dump body latching system shown in FIGS. 5 and 6;

FIG. 8 is a front view of the self-dumping hopper and dump body latching system of FIG. 5 illustrated in a dumping mode; and

FIG. 9 is a front view of the dump body latching system, in accordance with another aspect of an exemplary embodiment.

### BRIEF DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

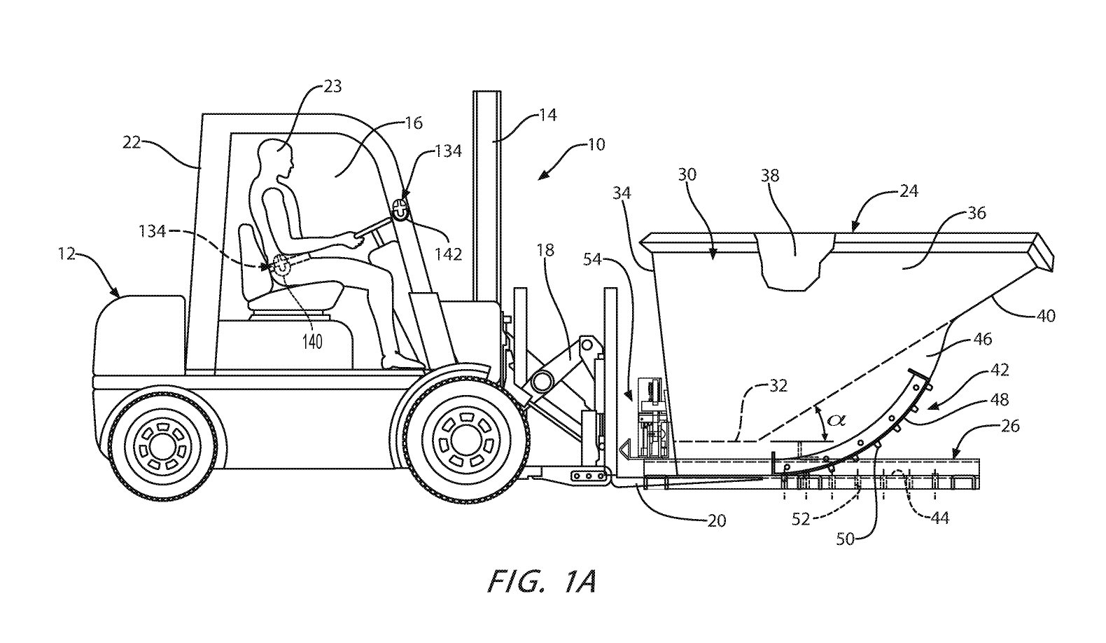

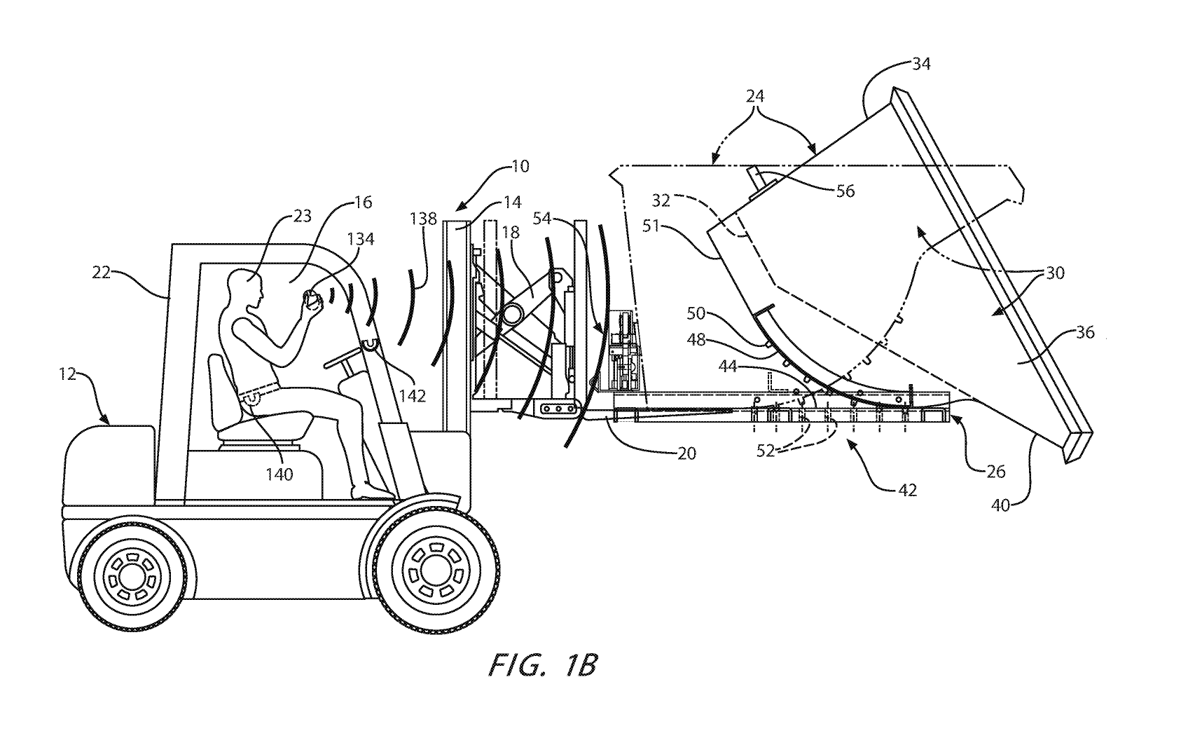

In accordance with an exemplary embodiment, FIGS. 1A and 1B schematically illustrate a fork truck 10 having a wheel supported body section 12, an upright 14, an operators compartment 16, outrigger arms 18 extending forwardly of the body section 12, and a pair of fork tines 20 associated with the outrigger arms 18 for engaging a variety of cargo that is moveable and placeable by the fork truck. The fork truck 10 may include a safety cage 22 that extends about and defines the operator's compartment 16. The safety cage 22 is intended to protect the operator 23 should cargo being moved/placed by the fork truck 10 become unstable and fall. It should be apparent that, during operation of the fork truck 10, the operator is in a preferred location when he or she remains in the operators compartment 16 surrounded by the safety cage 22.

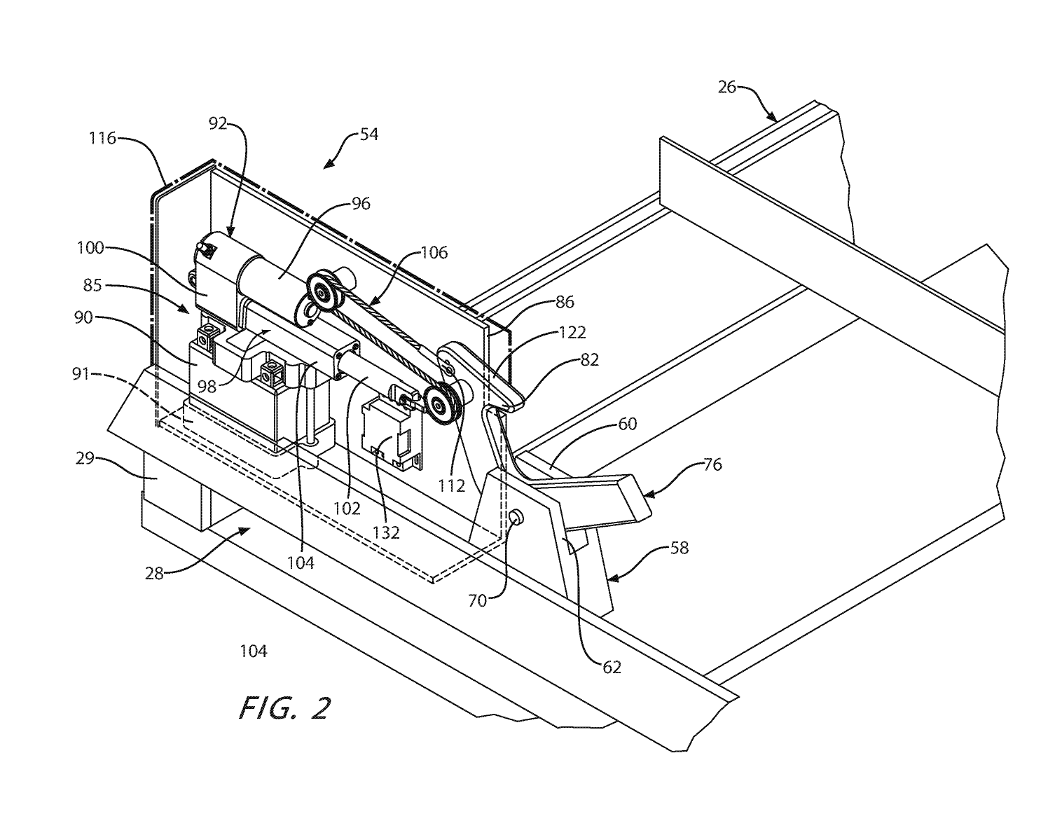

Referring to FIGS. 1A, 1B and 2, a self-dumping hopper (hopper) 24 is provided. The hopper 24 includes a base platform 26 that includes a lift opening or openings 28 that are configured to accept the fork tines 20 of the fork truck 10 for the purpose of lifting, moving and positioning the self-dumping hopper 24 by the fork truck 10. The opening(s) 28 may be defined by supports 29 that extend below and support the base platform 26. Mounted on the base platform 26 is a dump body 30 that includes a planar bottom portion 32 adapted to rest in a generally parallel relationship to the base platform 26 when the dump body 30 is retained in a first, upright position, FIG. 1A, for filling or storing of material. Back and side panels 34 and 36, respectively, extend upwardly from the bottom portion 32 to partially define an interior container portion 38 of the dump body 30. A front panel 40 completes the interior container portion 38 and extends from the horizontal bottom portion 32 outwardly (i.e. towards the front of the hopper 24) at an angle (“α”) such that the surface area of the front panel 40 is greater than that of the bottom portion 32 to thereby define a dump body geometry that, especially when filled, is biased to allow the hopper to be easily tilted forward, towards a second, emptying position, shown in FIG. 1B.

In an exemplary embodiment, a tracked pivoting system, referred to generally as 42, is incorporated into the base platform 26 and the dump body 30 and is configured to provide for controlled emptying of the dump body 30 of the self-dumping hopper 24. The tracked pivoting system 42 includes trunnion tracks 44 that extend longitudinally from front to back along the outer edges of the base platform 26. Rocker plates 46 extend downwardly from the outer edges of side panels 36 to terminate in curved edge surfaces 48 that are configured to engage, and roll along, the trunnion tracks 44 allowing the dump body 30 to be rotated in a forward (and backward) direction. The curved edge surfaces 48 terminate in rearward extending flat portions 51 that will maintain the dump body 30 in the first, upright position for filling or storing of material. Spaced trunnion pins 50 extend outwardly from the curved edge surfaces 48 of the rocker plates 46 and are configured to engage a series of spaced openings 52 in the trunnion tracks 44 during rotation of the dump body 30. The engagement of the trunnion pins 50 with the spaced trunnion openings 52 in the trunnion tracks 44 operate to confine the dump body 30 against lateral shifting movement as it is tilted. Suitable stops (not shown) will limit the forward rotating movement of the dump body 30.

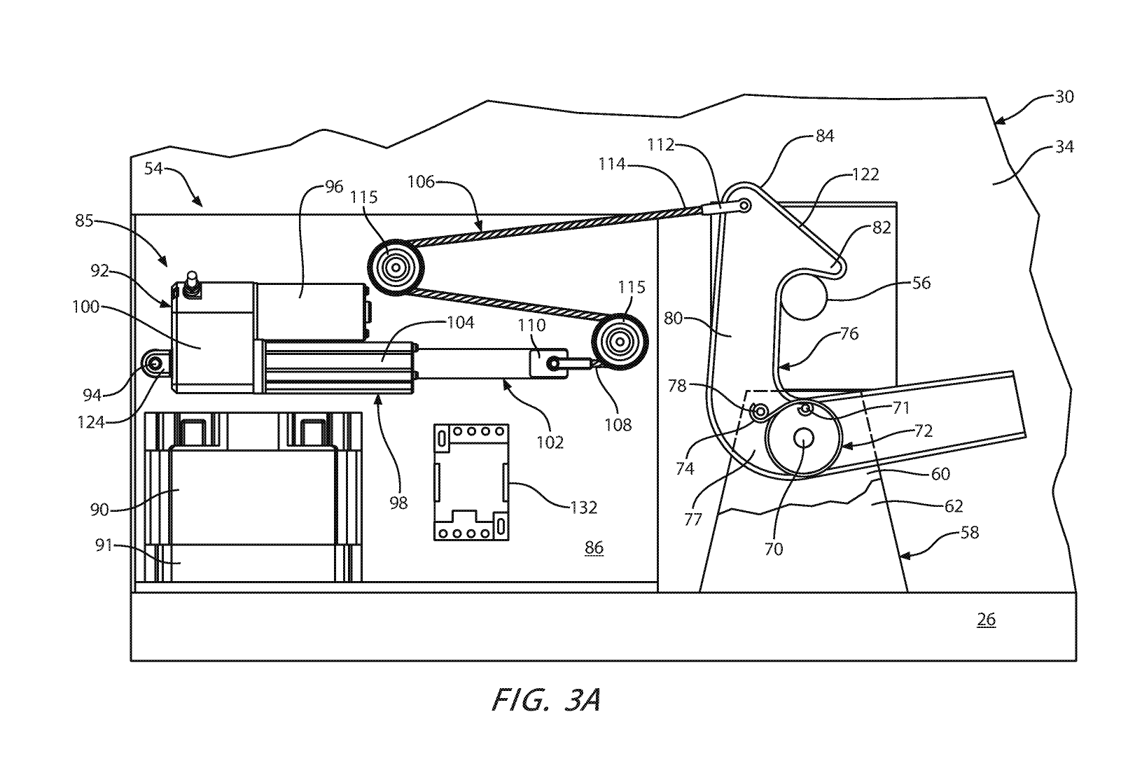

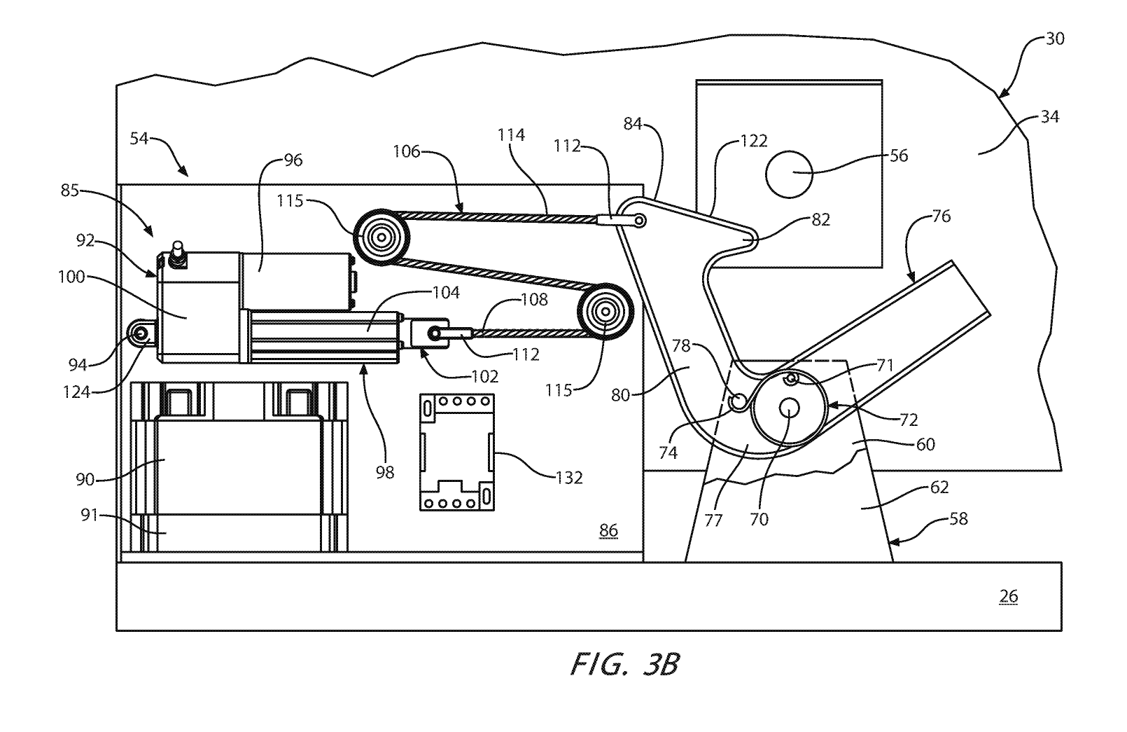

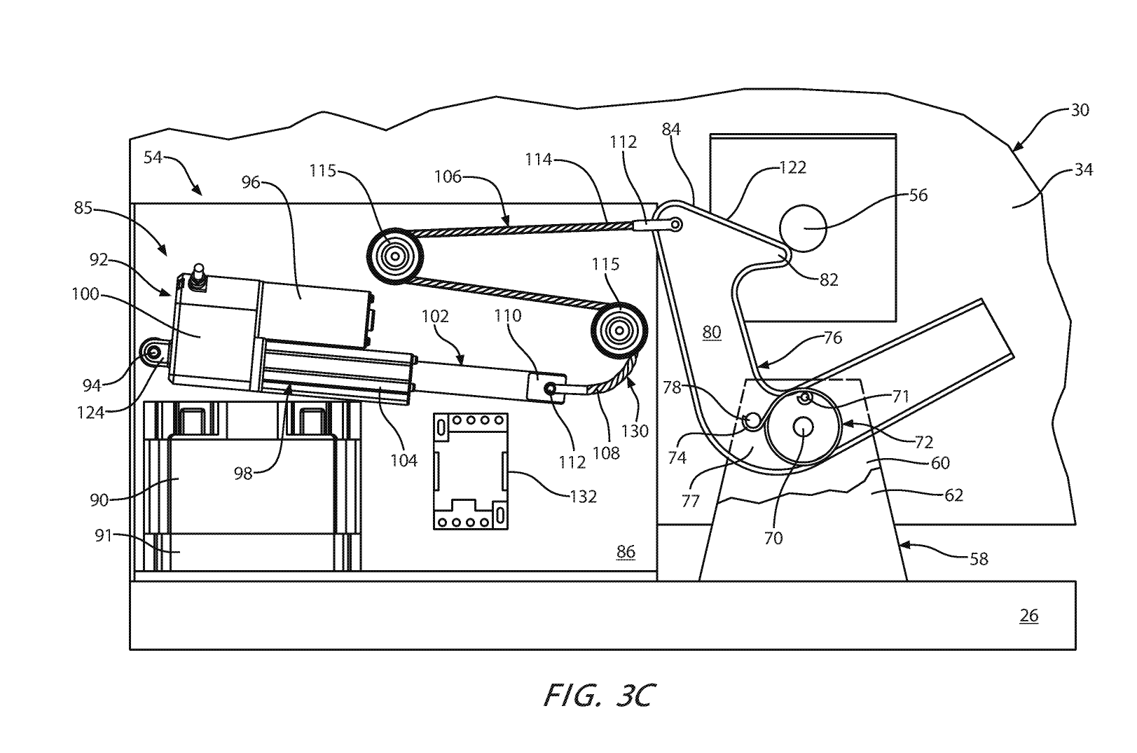

In an exemplary embodiment illustrated in FIGS. 2 and 3A-C, a dump body latching system, referred to generally as 54 is associated with the base platform 26 and is configured to engage a locking pin 56 that extends from the back panel 34 of the dump body 30. It is also contemplated that the locking pin 56, or additional locking pins 56, may extend from a side panel 36, and include a latching mechanism closely associated therewith, without deviating from the scope of the invention. In an exemplary embodiment, the dump body latching system 54 may be configured to include a double bracket 58 that is welded or otherwise fixed to the base platform 26 and extends upwardly therefrom. The double bracket 58 includes spaced bracket portions 60 and 62 that each include openings that share a common axis for receipt of a pivot pin 70 therein. The pivot pin 70 is configured to receive, and anchor, a first end 71 of a concentric coil spring 72. A second end 74 of the concentric coil spring is secured at securing point 78, to a first, lower end 77 of a trip lever 76 that is pivotally mounted on the pivot pin 70, adjacent to the concentric coil spring 72 and between the spaced bracket portions 60, 62. The trip lever has an upwardly extending arm portion 80 that includes a hook portion 82 located at a second end 84 thereof. The hook portion 82 is adapted to extend over the locking pin 56 on the dump body 30 to maintain the dump body 30 securely in its first, fixed or fill position (i.e. for receiving or storing material). The concentric coil spring 72 is preloaded such that it urges the hook portion 82 of the trip lever 76 into engagement with the locking pin 56, as a default. It should be appreciated that the embodiment described discloses the use of a concentric coil spring for biasing the trip lever 76 into a latched position with respect to the locking pin 56 of the dump body 30. However, it is contemplated that other suitable biasing mechanisms such as extension springs, spring loaded struts, torsion springs and the like may be used as well.

In order to release the trip lever 76, to thereby allow for forward pivoting of the dump body 30 to a second, emptying position, FIG. 1B, the dump body latching system 54 comprises, in an exemplary embodiment, a trip lever release module 85 that is mounted to the base platform 26 using, for instance, a support bracket 86. The support bracket 86 is configured to support the various components to be herein described. An electrical power source such as battery 90 is mounted in battery box 91 within the release module 85. The battery 90 provides electrical power to an electric linear actuator assembly 92 that is mounted for pivotal rotation within the housing about mounting pin 94.

In an exemplary embodiment, the linear actuator assembly comprises an electric motor 96, a linear actuator 98 and a transfer box 100 disposed therebetween and operationally interconnecting the two. The linear actuator 98 includes an actuator cylinder or rod 102 that is slidingly disposed within a tubular housing 104. In an exemplary embodiment, when electrical power from the battery 90 is applied to the electric motor 96 the rotation of the shaft (not shown) of the electric motor is transferred to the actuator rod through a gear or belt reduction (not shown) in the transfer box 100. Rotation of a portion of the actuator cylinder or rod 102 within the housing 104 results in its extension from, or retraction into the housing 104, FIGS. 3A and 3B, in a known manner.

In an exemplary embodiment, an actuator cable 106 is attached at a first end 108 to the terminal end 110 of the actuator cylinder or rod 102. The attachment may be through the use of a cable grommet 112 or other suitable mechanism for attachment of the first end 108 of the actuator cable 106 to the actuator cylinder or rod 102. A second end 114 of the actuator cable 106 is attached to the second end 84 of the upwardly extending arm portion 80 of the trip lever 76. As described, the attachment may be through the use of a cable grommet 112 or other suitable mechanism for attachment of the second end 114 of the actuator cable 106 to the trip lever 76. Disposed at horizontally and vertically spaced positions between the first end 108 and the second end 112 of the actuator cable 106 is one or more pulleys 115 about which the actuator cable 106 is wound. The pulley or pulleys 115 provide support for the actuator cable 106 between the terminal end 110 of the actuator cylinder or rod 102 and the second end 84 of the upwardly extending arm portion 80 of the trip lever 76. The pulley(s) 115 position the second end 114 of the actuator cable in a near horizontal position relative to the second end 84 of the trip lever 76 to thereby facilitate an unlocking motion when the dump body latching system 54 is activated.

Referring to FIG. 3A, in an exemplary embodiment, during filling and storage of material in the dump body 30 of the self-dumping hopper 24, as well as during movement and/or placement thereof, the actuator cylinder or rod 102 of the linear actuator 98 is in an extended position to thereby allow the actuator cable 106 sufficient length for the concentric coil spring 72 to bias the hook portion 80 of the trip lever into position over the locking pin 56.

When the fork truck 10 has positioned the self-dumping hopper 24 in an appropriate position for emptying its contents, FIG. 1B, power from the battery 90 is delivered to the electric motor 96 of the linear actuator assembly 92. The cylinder rod 102 of the linear actuator assembly is withdrawn into the tubular housing of the linear actuator 98, FIG. 3B. As the cylinder rod 102 is withdrawn, the cable 106 pulls the second end 84 of the trip lever 76, and the associated hook portion 82 in a counter clockwise direction about the pivot pin 70 and against the bias of the concentric coil spring 72, to disengage the hook portion 82 from the dump body locking pin 56. Upon such disengagement, the weight biased dump body 30 will be urged by its load biased geometry to be easily tilted forward on trunnion tracks 44 towards its second, emptying position.

Following disengagement of the hook portion 82 of the trip lever 76 from the locking pin 56, resulting in forward rotation of the dump body 30, the electric drive motor 96 reverses the direction of the actuator cylinder rod 102 and returns it to the extended position. When the dump body 30 of the self-dumping hopper 24 is empty, the dump body is returned to its fill position FIG. 1A by rotating it rearwardly until the planar bottom portion 32 is generally horizontal and the locking pin 56 is reengaged under the hook portion 82 of the trip lever 76. In an exemplary embodiment, as the dump body 30 approaches its locked position, the locking pin will engage the ramped outer surface 122 of the locking pin 56, FIG. 3C, which has been returned to its locked position by the re-extension of the cylinder rod 102 and the biasing of the trip lever 76 by the concentric coil spring 72. The weight and downward movement of the dump body 30 will displace the trip lever 76 against the bias of the coil spring 72 enough for the locking pin 56 to clear the hook portion 82 and return to the locked position relative to the dump body latching system 54. As the trip lever 76 is rapidly displaced by the locking pin 56, the actuator cable 106 will experience a momentary slack 130 as the second end 114 is suddenly moved by the rotating trip lever 76 without a concomitant shortening of the cylinder rod 102 by the linear actuator assembly 92. In an exemplary embodiment it may be necessary to take up such cable slack 130 to avoid disengagement from the pulley(s) 115.

In the embodiment shown in FIGS. 3A through 3C, the linear actuator assembly 92 is pivotally mounted to the support plate 86 at pivot mount 124 that extends from the end of transfer box 100. The pivot mount 124 includes the mounting pin 94 extending therethrough, and is configured to allow the linear actuator assembly 92 to pivot thereabout, FIG. 3C, and to maintain tension in the cable 106 by taking up any momentary slack 130 that may result from the sudden movement of the trip lever 76 caused by the strike of the locking pin 56 thereagainst as the dump body 30 returns to the locked position for receiving or storing material.

The self-dumping action just described may be carried out by the fork truck operator 23 from the confines of the safety cage 22 protected operator's compartment 16. An electronic receiving unit or controller 132 is mounted on the support plate 86 within the trip lever release module 85. As used herein, the term controller may refer to an application specific integrated circuit (ASIC), an electronic circuit, a processor (shared, dedicated, or group) and memory that executes one or more software or firmware programs, a combinational logic circuit, and/or other suitable components that provide the described functionality. The controller is configured to receive one or more signals from an actuator 134. The signals, when received, will command the electric motor 96 of the linear actuator assembly 82 to drive the actuator rod 102 inwardly or outwardly, for instance. The rod may also be self-returning using a stop switch (not shown) inside of the tubular housing 104.

The actuator 134 may be hard wired to the controller 132 or, in an exemplary embodiment and as illustrated in FIGS. 1A and 1B, may comprise a wireless transmitter 134 that may be portable and carried by the operator 23 in a manner similar to a battery powered, wireless key fob. The wireless transmitter 134 may produce a coded signal 138 that is individually selected for, and recognizable by the controller 132. Such coding is provided in order to prevent one wireless transmitter from operating more than one dump body latching system 54. The wireless transmitter 134 may be compact enough to be worn on the operator 23 in a holster-type device 140, held in a receiver 142 attached to the fork truck 10 or may include a magnetic portion configured to allow the wireless transmitter to be magnetically attached to the fork truck 10 or to the self-dumping hopper 24.

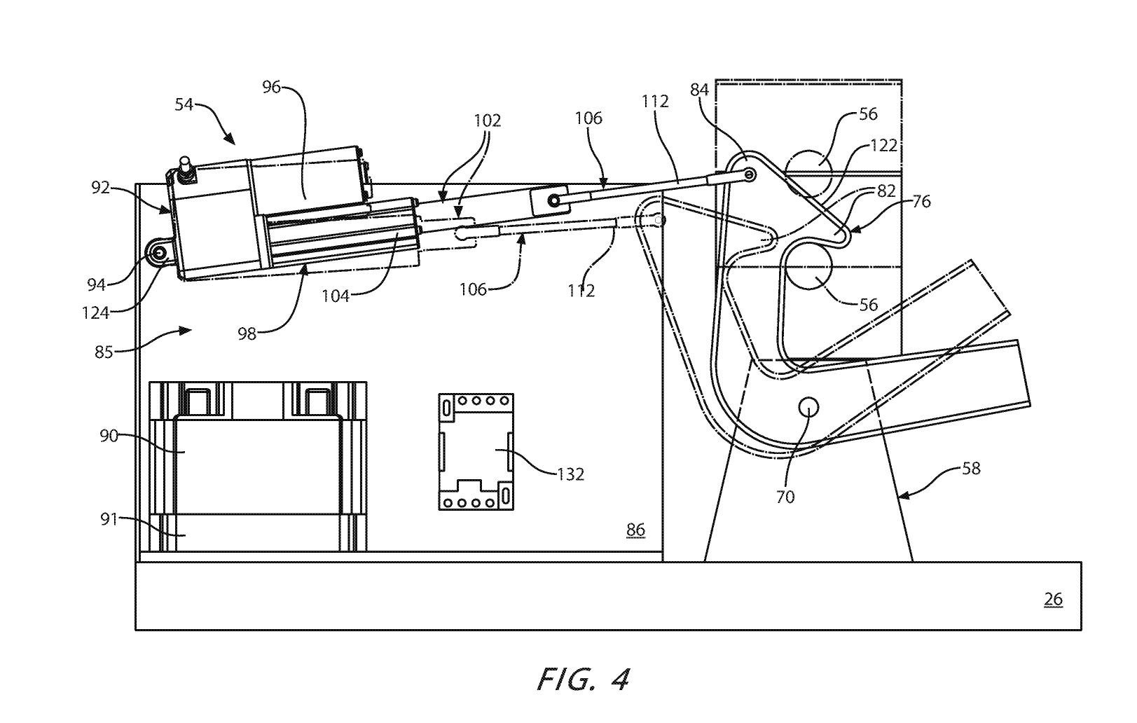

Referring now to FIG. 4, in another exemplary embodiment, the linear actuator assembly 92 may be alternately mounted within the trip lever release module 85 such that the actuator cylinder or rod 102 positions the second end 112 of the actuator cable 106 in a near horizontal position relative to the second end 84 of the trip lever 76 to thereby facilitate its unlocking when the dump body latching system 54 is activated. Such a placement of the linear actuator assembly allows for a shorter actuator cable 106 and dispenses with the requirement of pulleys to properly position the cable relative to the second end of the trip lever 76.

As described above, when the fork truck 10 has positioned the self-dumping hopper 24 in an appropriate location for emptying its contents, FIG. 1B, power from the battery 90 is delivered to the electric motor 96 of the linear actuator assembly 92. The cylinder rod 102 of the linear actuator assembly is withdrawn into the tubular housing 104 of the linear actuator 98. As the cylinder rod 102 is withdrawn, the cable 106 pulls the second end 84 of the trip lever trip lever 76, and the associated hook portion 82 in a counter clockwise direction about the pivot pin 70 (shown in phantom in FIG. 4), and against the bias of the concentric coil spring 72, to disengage the hook portion 82 from the dump body locking pin 56. The slight change in elevation of the second end 84 of the trip lever 76 is accommodated by a rotation of the linear actuator assembly 92 about the mounting pin 94 of its associated pivot mount 124. Upon such disengagement, the weight biased dump body 30 will be urged by its load biased geometry to be easily tilted forward on trunnion tracks 44 towards its second, emptying position, shown in FIG. 1B.

Following disengagement of the hook portion 82 of the trip lever 76 from the locking pin 56, resulting in forward rotation of the dump body 30, the electric drive motor 96 reverses the direction of the actuator cylinder rod 102 and returns it to the extended position FIG. 4. When the dump body 30 of the self-dumping hopper 24 is empty, the dump body is returned to its fill position, FIG. 1A, by rotating it rearwardly until the planar bottom portion 32 is generally horizontal and the locking pin 56 is reengaged under the hook portion 82 of the trip lever 76. In an exemplary embodiment, as the dump body 30 approaches its locked position, the locking pin 56 will engage the ramped outer surface 122 of the trip lever 76 which has been returned to its locked position by the re-extension of the cylinder rod 102 and the biasing of the trip lever 76 by the concentric coil spring 72. The weight and downward movement of the dump body 30 will displace the trip lever against the bias of the coil spring enough for the locking pin to clear the hook portion 82 and return to the locked position relative to the dump body latching system 54. As the trip lever 76 is rapidly displaced by the locking pin 56, the actuator cable 106 will experience a slackening as the second end 114 is suddenly moved by the rotating trip lever 76 without a concomitant shortening of the cylinder rod 102 by the linear actuator assembly 92. Such slackening will be taken up by the trip lever 76 under the bias of the concentric coil spring 72 once the pin 56 has cleared the ramp 122 and is engaged under the hook portion 82.

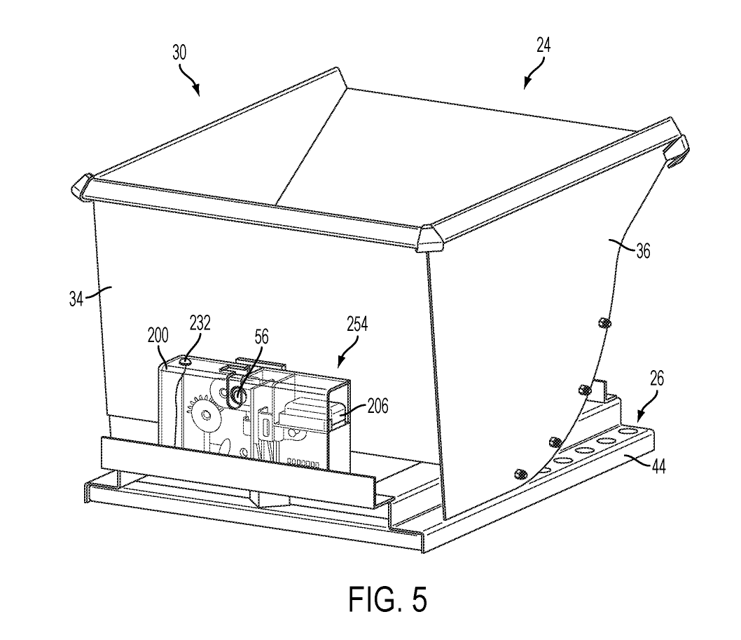

Referring now to FIGS. 5-8, in another exemplary embodiment, a dump body latching system, referred to generally as 254 is associated with the base platform 26 and is configured to engage the locking pin 56 that extends from the back panel 34 of the dump body 30. It is also contemplated that the locking pin 56, or additional locking pins 56, may extend from the side panel 36, and include a latching mechanism closely associated therewith, without deviating from the scope of the invention.

In an exemplary embodiment, the dump body latching system 254 may be configured to include a housing 200, a latch actuator assembly 202, a communication unit 204, and an electrical power source such as battery 206.

The latch actuator assembly 202 includes a geared actuator 208, a latching member 210, and a release solenoid or actuator 212. The geared actuator 208 is rotatably coupled to the housing 200 and includes a contact arm 214 and a plurality of gear teeth 216. The latching member 210 is rotatably coupled to the housing 200 and includes a pair of release arms 218 and a plurality of gear teeth 220. The release arms 218 are configured to selectively engage the locking pin 56, and the teeth 220 are configured to meshingly engage the teeth 216 of the geared actuator 208. The geared actuator 208 and/or the latching member 210 are locked in the position illustrated in FIGS. 5-7 until engaged, to prevent premature rotation of dump body 30. The actuator 212 may include a linearly translating cylinder or rod 222 configured to selectively engage the first actuator contact arm 214 to cause rotation of the geared actuator 208.

The communication unit 204 may include a wireless transmitter 224 and an electronic receiving unit or controller 226 that is disposed within the housing 200. The controller 226 is mounted within the housing 200 and is configured to receive one or more signals from an actuator such as wireless transmitter 224. The signal(s) when received will command release actuator 212 to drive the linearly translating cylinder 222 inwardly or outwardly, for instance. The wireless transmitter 224 may be portable and carried by the operator 23 in a manner similar to a battery powered, wireless key fob. The wireless transmitter 224 may produce a coded signal 228 that is individually selected for, and recognizable by the controller 226. Such coding is provided in order to prevent one wireless transmitter from operating more than one dump body latching system 254. The wireless transmitter 224 may be compact enough to be worn on the operator 23 in the holster type-device 140, held in the receiver 142, or may include a magnetic portion configured to allow the wireless transmitter 224 to be magnetically attached to the fork truck 10 or to the self-dumping hopper 24. Alternatively, an actuator (not shown) may be hard wired to the controller 226 for direct rather than wireless communication.

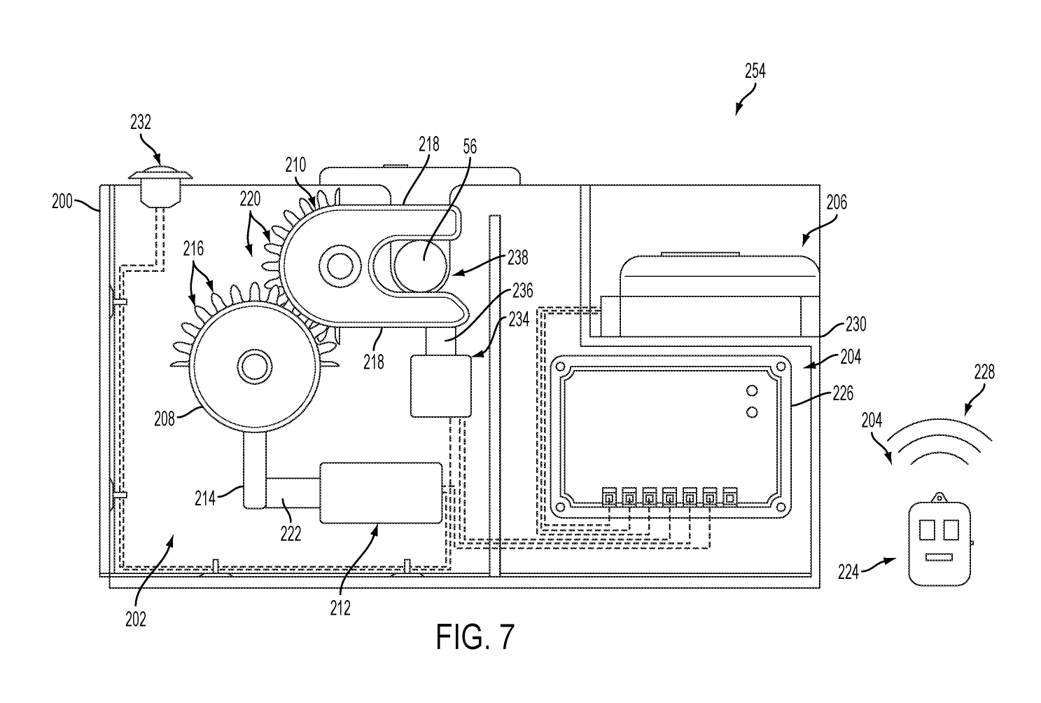

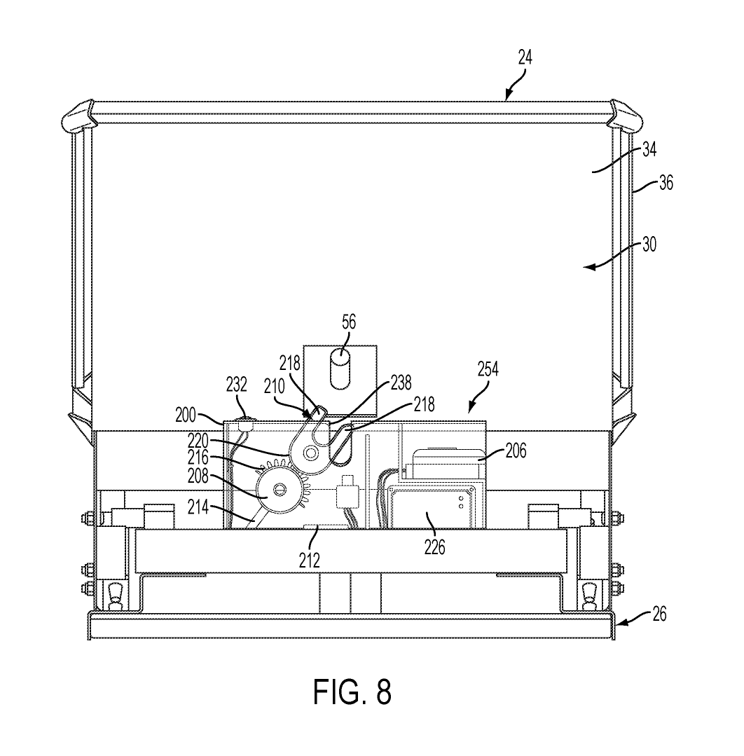

In the exemplary embodiment, battery 206 is mounted in a battery box 230 within housing 200. The battery 206 provides electrical power to the latch actuator assembly 202 and the controller 226. Additionally, the latching system 254 may include a power switch 232 and a shut-off switch 234. The power switch 232 is configured to selectively power the latching system 254 for operation, and the shut-off switch 234 is configured to selectively power-off the latching system 254 when engaged (e.g., when a linearly translating cylinder or rod 236 of the switch 234 is released or extended, FIG. 8). Alternatively, the shut-off switch 234 may power-off the latching system 254 when in the locked position (FIG. 7) until a certain condition is met (e.g., activating power switch 232).

Referring to FIGS. 5-7, in an exemplary embodiment, during filling and storage of material in the dump body 30 of the self-dumping hopper 24, as well as during movement and/or placement thereof, the actuating cylinder 222 of release actuator 212 is in a retracted position.

With further reference to FIG. 8, when the fork truck 10 has positioned the self-dumping hopper 24 in an appropriate position for emptying its contents, the wireless transmitter 224 is directed to send the coded signal 228 (FIG. 7) to the controller 226, which actuates the release actuator 212 to extend the actuating cylinder 222. As the actuating cylinder 222 is extended, it engages first actuator contact arm 214, which causes rotation of the geared actuator 208 in the clockwise direction. Due to the meshed engagement between teeth 216, 220, rotation of the geared actuator 208 causes rotation of the latching member 210 in the counter clockwise direction such that the dump body locking pin 56 passes through a latch member open end 238 between the release arms 218 (FIG. 8). Upon disengagement of the locking pin 56 from between the release arms 218, the weight biased dump body 30 will be urged by its load biased geometry to be easily tilted forward on trunnion tracks 44 (FIG. 5) towards its second, emptying position (e.g., FIG. 1B).

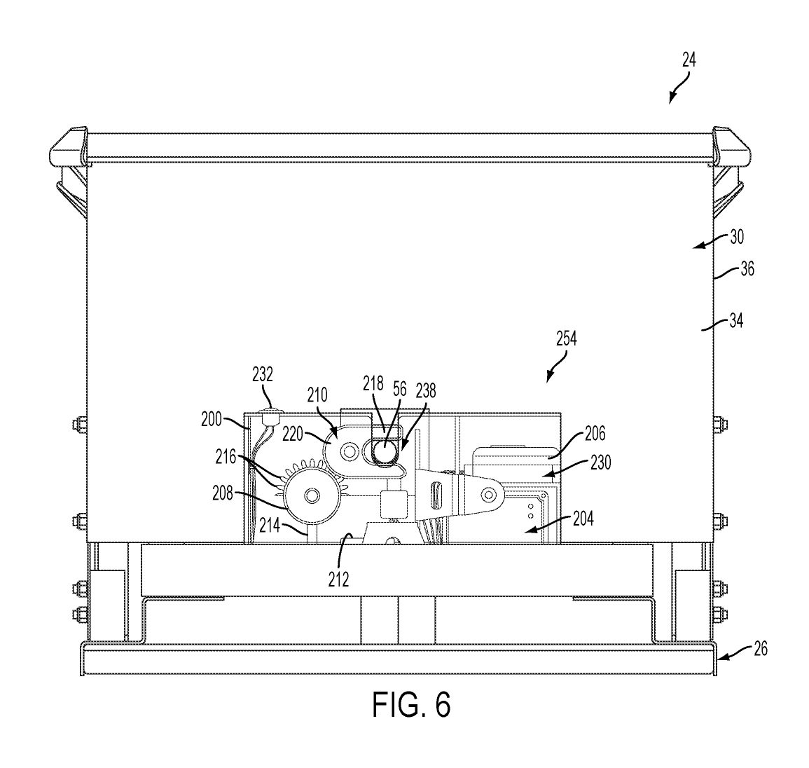

Following release of the locking pin 56, latching member 210 contacts and depresses cylinder 236, which powers off controller 226 to conserve energy usage from the power source 206. When the dump body 30 of the self-dumping hopper 24 is empty, the dump body is returned to its fill position (e.g., FIGS. 1A and 5) by rotating it rearwardly until the planar bottom portion 32 is generally horizontal and the locking pin 56 is reengaged between the release arms 218 of the second actuator (FIG. 6). In an exemplary embodiment, as the dump body 30 approaches its locked position, the cylinder 222 of the release actuator 212 is withdrawn (e.g., by controller 226 or because power has been shut off), and the locking pin 56 will engage the lower release arm 218 of the latching member 210. This causes clockwise rotation of the latching member 210, which causes counterclockwise rotation of the geared actuator 208 (and the latch actuator assembly 202) back into its initial locked position (FIGS. 5-7).

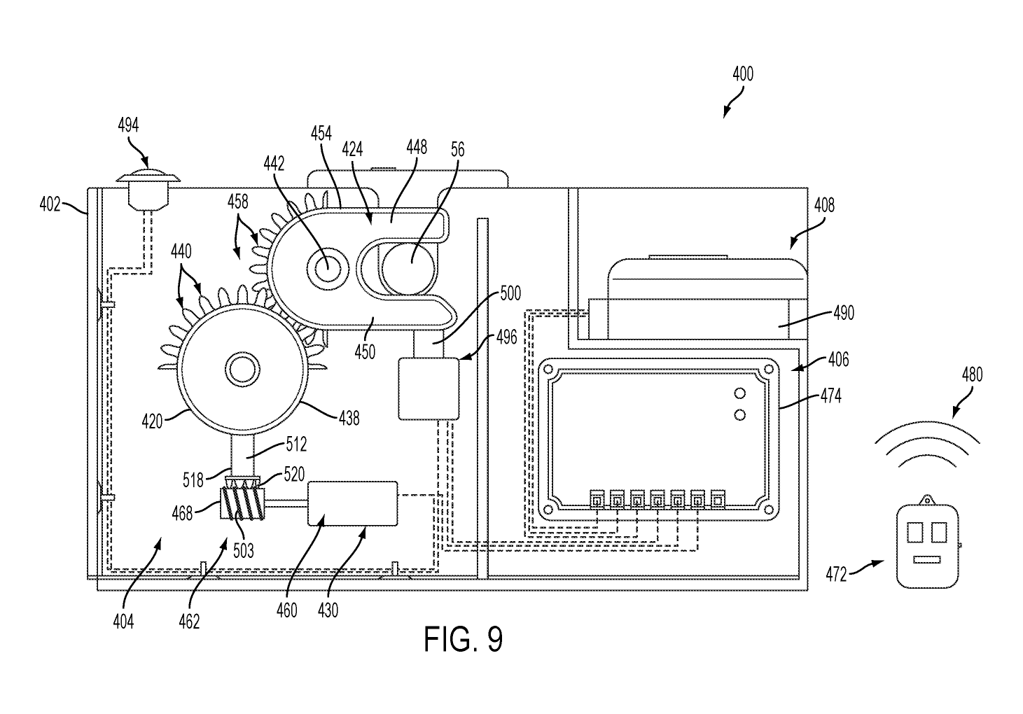

A dump body latching system, in another exemplary embodiment, is illustrated generally at 400 in FIG. 9. Dump body latching system 400 is associated with the base platform 26 and is configured to engage the locking pin 56 that extends from the back panel 34 of the dump body 30. It is also contemplated that the locking pin 56, or additional locking pins 56, may extend from the side panel 36, and include a latching mechanism closely associated therewith, without deviating from the scope of the invention.

In an exemplary embodiment, the dump body latching system 400 may be configured to include a housing 402, a latch actuator assembly 404, a communication unit 406, and an electrical power source such as battery 408. Latch actuator assembly 404 includes a geared actuator 420, a latching member 424, and a release actuator 430. Geared actuator 420 is rotatably supported in housing 402 and includes an outer surface 438 from which project a plurality of gear teeth 440. Latching member 424 is rotatably supported upon an axle 442 coupled to housing 402 and includes a pair of release arms 448 and 450. Latching member 424 also includes an outer surface portion 454 from which project a plurality of gear teeth 458. Release arms 448 and 450 are configured to selectively engage the locking pin 56. Gear teeth 458 are configured to meshingly engage with gear teeth 440 of geared actuator 420. Geared actuator 420 and/or latching member 424 are locked in the position illustrated in FIG. 9 until disengaged. In this manner, premature rotation of dump body 30 may be prevented. Release actuator 430 may take the form of a rotary actuator 460 supporting a gear member 462. Gear member 462 may take the form of a worm gear 468. As will be detailed below, release actuator 430 may be selectively activated to shift latching member 424 between a latched configuration (FIG. 9) and an unlatched configuration.

Communication unit 406 may be operatively associated with a wireless transmitter 472 that communicates with an electronic receiving unit or controller 474 disposed within the housing 402. Controller 474 is configured to receive one or more signals 480 from wireless transmitter 472. Signal(s) 480 when received by controller 474 will activate release actuator 430 to rotate gear member 462. Wireless transmitter 472 may be portable and carried by the operator 23 in a manner similar to a battery powered, wireless key fob. Wireless transmitter 472 when activated produces signal(s) 480 which may be individually selected for, and recognizable by the controller 474. Such coding is provided in order to prevent one wireless transmitter from operating more than one dump body latching system 400. Wireless transmitter 472 may be compact enough to be worn on the operator 23 in the holster type-device 140, held in the receiver 142, or may include a magnetic portion configured to be magnetically attached to the fork truck 10 or to the self-dumping hopper 24. Alternatively, an actuator (not shown) may be hard wired to the controller 474 for direct rather than wireless communication.

In the exemplary embodiment, battery 408 is mounted in a battery box 490 arranged within housing 402. Battery 408 provides electrical power to the latch actuator assembly 404 and the controller 474. Additionally, the dump body latching system 400 may include a power switch 494 and a shut-off switch 496. Power switch 494 is configured to selectively power latching system 400 for operation, and the shut-off switch 496 is configured to selectively power-off the latching system 400 when in the locked position when engaged by, for example, release arm 450 until a certain condition is met (e.g., receipt of signal 480 from wireless transmitter 472. That is, shut-off switch 496 may include a button 500 that may be engaged by release arm 450 when in the latched configuration.

During filling and storage of material in the dump body 30 of the self-dumping hopper 24, as well as during movement and/or placement thereof, the latching system 400 is in a latched configuration. After fork truck 10 has positioned the self-dumping hopper 24 in an appropriate position for emptying its contents, wireless transmitter 472 is directed to send the coded signal 480 to controller 474, which actuates the release actuator 430 causing gear member 462 to rotate. Gear member 462 includes a single gear tooth 503 that engages with a contact arm 512 operatively connected to geared actuator 420. Contact arm 512 includes a cantilevered end 518 having a plurality of gear teeth 520 that engage with gear tooth 503 on gear member 462. Rotation of gear member 462 causes contact arm 512 to pivot leading to a rotation of geared actuator 420. Rotation of geared actuator 420 is imparted to latching member 424. Latching member 424 pivots releasing locking pin 56 allowing dump boy 30 to pivot forward.

Self-dumping hopper 24 may be returned to a fill position (e.g., FIGS. 1A and 5) by rotating dump body 30 rearwardly until the planar bottom portion 32 is generally horizontal and the locking pin 56 is reengaged between the release arms 448 and 450. In an exemplary embodiment, as the dump body 30 approaches its locked position, locking pin 56 will engage release arm 450 of the latching member 424 which may cause gear member 462 to rotate in a reverse direction. Once release arm 450 activates button 500, release actuator 430 is powered off and dump body 30 is retained in the fill position.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. A dump body latching system for application to a self-dumping hopper having a base platform, a rotatable dump body mounted thereto and a locking pin on the rotatable dump body, the dump body latching system configured to control rotation of the rotatable dump body thereon and comprising:
a power source;
an actuator assembly including an actuator; and
a controller operably connected to the actuator, the controller operating to selectively connect the power source with the actuator to selectively disengage the locking pin.

2. The dump body latching system of claim 1, wherein the actuator assembly comprises a geared actuator and a latching member selectively restraining the locking pin, the geared actuator being operatively connected to the latching member.

3. The dump body latching system of claim 2, further comprising a housing, wherein the geared actuator and the latching member are rotatably supported in the housing.

4. The dump body latching system of claim 2, further comprising: a contact arm coupled to the geared actuator, the contact arm being configured to be selectively shifted by the actuator.

5. The dump body latching system according to claim 4, wherein the actuator includes a gear member operatively engaged with the geared actuator.

6. The dump body latching system according to claim 5, wherein the gear member comprises a worm gear.

7. The dump body according to claim 5, wherein the gear member includes a first plurality of gear teeth and the contact arm includes a second plurality of gear teeth, wherein the gear member is operatively connected to the geared actuator through the contact arm.

8. The dump body latching system of claim 1, wherein the controller is an electronic receiving unit configured to receive one or more signals which, when received will command the actuator assembly to drive the actuator.

9. The dump body latching system of claim 8, wherein the actuator comprises a wireless transmitter.

10. The dump body latching system of claim 9, wherein the wireless transmitter is portable.

11. The dump body latching system of claim 1, further comprising a shut-off switch selectively engageable by the actuator assembly, the shut-off switch configured to turn off the dump body latching system when the shut-off switch is engaged by the actuator assembly.

12. The dump body latching system of claim 1, wherein the power source is a battery.

13. The dump body latching system according to claim 1, wherein the actuator comprises a rotary actuator.

14. A self-dumping hopper comprising:
a base platform;
a rotatable dump body mounted to the base platform and including a locking pin on the rotatable dump body; and
a dump body latching system configured to control rotation of the rotatable dump body on the base platform, the dump body latching system comprising:
an actuator assembly including an actuator; and
a controller operably connected to the actuator, the controller operating to selectively disengage the dump body latching system from the locking pin.

15. The self-dumping hopper according to claim 14, wherein the actuator assembly comprises a geared actuator and a latching member selectively restraining the locking pin, the geared actuator being operatively connected to the latching member.

16. The self-dumping hopper according to claim 15, further comprising: a contact arm coupled to the geared actuator, the contact arm being configured to be selectively shifted by the actuator.

17. The self-dumping hopper according to claim 16, wherein the actuator includes a gear member operatively engaged with the geared actuator.

18. The self-dumping hopper according to claim 17, wherein the gear member comprises a worm gear.

19. The self-dumping hopper according to claim 17, wherein the gear member includes a first plurality of gear teeth and the contact arm includes a second plurality of gear teeth, wherein the gear member is operatively connected to the geared actuator through the contact arm.

20. The self-dumping hopper according to claim 15, wherein the actuator comprises a rotary actuator.
